(19) United States
(12) Patent Application Publication
(10) Pub. No.: US 2008/0005027 A1
(43) Pub. Date: Jan. 3, 2008

(54) System and methods for transmission of media files across a telephone, internet, intranet, satellite, cable or combination network to avoid unpaid digital file sharing or copying

(76) Inventor: John Jason Gentry Mullins, Pleasanton, CA (US)

Correspondence Address: John J G Mullins, 1618 East Gate Way #304, Pleasanton, CA, 94566, US

(21) Appl. No.: 11/453,554

(22) Filed: Jun. 14, 2006

(51) Int. Cl. G06Q 10/00

(52) U.S. Cl. 705/51; 705/5

(57) ABSTRACT

The present invention provides a business method, computer system and software implemented methods that provide for secure and high speed transmission or distribution of media files across a telephone, internet, intranet, satellite, cable or combination network decoupled from digital media file access rights, and a method to avoid digital file sharing or copying without direct or indirect payment of user fees. More particularly, the invention includes the use of a proprietary encryption technique for digital media files, a proprietary reassembly process for digital media files and unique user keys, wherein the access to a digital media file or portion thereof is controlled by the digital media rights of the key or digital media access card, which access may be constrained to a particular machine, a particular user, a particular period of time, or a combination thereof. This method permits peer to peer transmission of information without piracy of the media, such that access can be paid for by a third party or can be paid for by end user, and digital media rights licenses may optionally provide for a transfer of digital media rights for a particular digital media file.

### TECHNICAL FIELD

The present invention relates generally to a business method, computer system and software implemented methods that provide for secure and high speed transmission of media files across a telephone, internet, intranet, satellite, cable or combination network, and a method to avoid digital file sharing or copying without direct or indirect payment of user fees. More particularly, the invention includes the use of a proprietary encryption technique for digital media files, a proprietary reassembly process for digital media files and unique user keys, wherein the access to a digital media file or portion thereof is controlled by the digital media rights of the key or digital media access card, which access may be constrained to a particular machine, a particular user, a particular period of time, or a combination thereof. This method permits peer to peer transmission of information without piracy of the media, such that access can be paid for by a third party or can be paid for by end user, and digital media rights licenses may optionally provide for a transfer of digital media rights for a particular digital media file.

### BACKGROUND

Illegal digital file sharing and pirating of media based digital recordings have increasingly become a problem on the internet or on other communication networks. Unlike traditional television media broadcasts and hard copy media tracking of the origin of digital media file copies and capturing revenue streams is increasingly difficult with peer to peer and server to client transfers, where copying and transmitting a digital file can be quite simple and quick. Further, with traditional broadcasts through TV, Cable TV, Cable Digital Audio, Satellite TV and Satellite digital audio, there are some mitigation of revenue streams for recorded media due to revenue obtained from paid advertisements to the media broadcaster with respect to a particular audience that allows payment to the media producer. Further, the amount of time necessary for an end user to record and re-transmit recorded media from traditional broadcasts (logos, copy protecting, advertising segments and other tracking mechanisms can also discourage copying) along with loss of quality during recording are factors that tend to limit the amount of pirating, re-transmission or unauthorized distribution of such recorded media.

Our research has indicated that published media producers would be happy with the enhanced and quicker sharing of media via the internet if adequate controls were in place. They would need to have a reliable method to adequately and efficiently manage and track file exchanges in such a way as to ensure obtaining proper payment for use of the media. However, there is currently no acceptable and efficient way for media producers to track such media file transfers in real time and to then collect the proper license fees for their use. At the present time both legal and illegal transfers of media routinely occur that are expensive to monitor for illegal transfers and then to collect legitimate royalty revenue from such illegal transfers.

Moreover, current file-sharing methods over the internet do not provide an efficient way to transfer media use fees from end user to advertisers of products that might be interested in paying media royalty or user fees on the behalf of certain end users in exchange for targeted advertising. The identity of the consumer audience on the internet is difficult to ascertain and effectiveness of internet advertising campaigns are difficult to accurately quantify. Usually, advertisements can only track the cost of clicks per thousand targeted internet viewers and cannot accurately correlate this information with real-time purchases of their advertised products in the real world or in real time.

Encryption methods for transmitted data have traditionally slowed the transmission of data to a point that end users do not want to use such systems or need to have a special and expensive translation unit provided by the media producer. Further, such encryption methods are often quickly broken by internet hackers or by hardware chip producers.

U.S. Pat. No. 5,818,935 issued to Maa relates to a method for including within a media stream an internet pointer (such as a URL) to a secret location for a media stream. This method is a clumsy attempt to regulate internet transfers of digital data from digital broadcasters and is similar to a secure cable or TV satellite system. It does not relate to direct transfers of digital media and does not use a high level encryption method. Further, Maa does not provide a means for advertisers to target particular end users with the ability to pay for their use of digital media if the end user agrees.

U.S. Pat. No. 6,357,042 issued to Srinivasan relates to a method for coordinating two streams of media data. In the '042 patent one stream of data is encoded as a digital recording with location “tags” for later inserting additional media. The main purpose seems to be to make a TV set interactive to enhance pay-per-view broadcasts. While this document alludes to later insertion of advertisement data, there is little information about how this is to be done. There are no details about data encryption and it appears that the encryption discussed is the encryption ordinarily present in satellite or cable TV broadcasts. No method for coordinating the end use with specific targeted advertisement is discussed.

U.S. Pat. No. 4,621,285 issued to Schilling relates to a method for separating out vertical and horizontal TV broadcast information and sending it unencrypted over a cable or satellite network. The data to synchronize the horizontal and vertical information is encoded or encrypted. The display system decodes the synchronization data, combines the horizontal and vertical information in a synchronized manner and displays the TV media. There is no discussion of digital media files or encoding the media stream. Advertising is not discussed in this document.

Accordingly, there is a strong need in the art for a business method and distribution system that could address or provide an answer for one or more of the three factors needed to solve the above mentioned problems; to provide for secure digital transfers, to adequate payment of end users or advertisers for use of the media, and provide a means for clearly identifying the end user of digital media no matter where the user obtained the media data. There is especially needed a method for transferring files in a proprietary format that can easily be changed or whose digital access rights can be managed, changed or terminated, and preferably for a method that utilizes distribution of digital media files in a smaller compressed and/or compacted manner in order to enhance transfer speeds where the system is nearly impossible to be broken and can be quickly changed or adapted to avoid problems when a code is broken.

### SUMMARY OF THE INVENTION

An object of the present invention is to provide software implemented methods, a computer system including software and hardware for such implemented methods, and a business method for accurately allowing end users of digital media files to pay for their access to such files, or a method for connecting end users of digital media files with product advertisers who wish to target them with selected advertisements and to pay for their digital media files access, whereby the method includes use of a computer system with at least one method step for accurately identifying the end user of the digital media or for accurately identifying a machine upon which a digital media file will be permissibly accessed, and at least one method step for an end user to authorize individual payment for digital media that will be acquired from a peer to peer download or from a server client download, or alternatively, for a product advertiser to use a computer system to authorize payment for such digital media access of an end user or end user machine by selecting the target group to which the end user belongs or to authorize payment for access to a digital media file that is likely to be accessed by a high percentage of end users belonging to a group desired to be targeted an advertiser.

In a preferred object of the invention, prior to accessing a digital media file that has been downloaded, or is about to be downloaded, from a server-client communication, from a peer to peer communication, or otherwise acquired, an end user will access a system interface presenting the end user with the choice of paying for their digital media access or for electing third party payment in exchange for permitting one or more advertisers or ads to be displayed for the end user. In a particularly preferred object, the business method comprises use of a computer system or other software implemented methods to register or record data of end users for a digital media access rights card whose unique identifier key (or keys) can be utilized in a system to initiate payment authorization or for initiating decoding of encrypted media or for permitting third party payment authorization prior to obtaining the right to decode encrypted media for access.

In one object of the invention, a digital media access card or key registration step may include requesting adequate information from the registering end user that is related to marketing factors such that the end user may be identified with a particular class of consumers that share at least one marketing factor in common, while optionally preserving their individual identities, or a particular digital media file may be associated with a particular class of consumers by the prior research of an advertiser with respect to the classes of persons that generally access such a digital media file. The digital media files access card or key may be cross-referenced with the end user's consumer information, or with a particular end user machine, and may be identifiable to a media player system having decoding information such that it will allow the digital media access card or key end to grant the end user access to digital media files by initiating decoding of such media files.

In an optional object of the invention, a digital media card or key can permit an end user to forego viewing an advertisement, or being targeted by an advertiser by agreeing to directly authorize their own payment of a media use fee for the right to access the digital media whereupon decoding can occur that is a result of cross-referenced authorized payment of the media use fee with a digital media rights access key that may be tracked by associated software logic to a particular end user, a particular machine, or both. The business method may comprise a method for encrypting and decoding (decrypting digital media) that is more fully described herein, or may use any other proprietary encrypting and decoding method that is acceptable to a digital media files owner.

It is an important object of the invention to provide a computer system (particularly a system attached to the internet) and a method for reliably encrypting a digital media file in a proprietary encrypted format that is reasonably secure against hackers. The digital media file is equipped with imbedded information regarding where advertisements can be inserted, or when advertisements can be played . . . such as before the media is played or simultaneously with the media in a window, banner or background. Further the digital media file may have imbedded information that can result in end user liability if the end user accesses or changes a digital media file or file component, or liability to a third party who impermissibly accesses a modified digital file or file component beyond the scope of the granted digital media rights.

A preferred object the invention includes the use of a proprietary encryption technique in combination with a proprietary decryption method for reassembling decoded fragments into a digital file in real time that will only initiate and continue decoding and reassembly of the media file, or a portion thereof, if unique user key(s) are present that give either the end user or the end user machine, or both, access to the digital media at the time of decoding and reassembly of the digital media file, or portion thereof.

In a preferred object of the invention, an encrypted reassembly index may be required to be present or accessible over a network before access to the digital media file or a portion thereof is available to an end user or an end user machine, or both.

It is another object of the invention to fragment a media file into media data packets (also known as bits, units, or objects of information) and encrypt the separate media file into uniquely identifiable packets whose order for decryption and playing of the packets is included within a separate encrypted reassembly index file, or the order is communicated in another proprietary manner such as by a software implemented method. In a preferred object the decryption information operates in real time and only provides a buffer of decrypted media information that exists in the memory of a computer while the media is being played, while the encrypted file or portions of the encrypted file, such as encrypted media data packets, may exist in a permanent media or only as part of a streaming media file available via a communications network, such as a satellite, cable, internet, intranet or telephone network. Preferably, encrypted packets are sent to the end-user in a non-linear or random fashion and may be simultaneously sent to an end user from multiple download server locations or from multiple peer to peer locations. One preferred object of the invention, is to provide peer to peer or bit torrent downloads of proprietary encrypted digital media files.

It is a preferred object of the invention to transmit the individual packets and the encrypted reassembly index file from multiple locations simultaneously and asynchronously to an end user via a true distributed intelligent torrent exchange (DITX) transmission. A DITX transmission may be generally described as a file exchange where a torrent of packets for a media file are sent from multiple locations on the internet (or from other network locations) to a media requesting end user who is asking for a particular media file (a torrent of packets is sent like a swarm of bees from different locations that have the packets available for sending) and individual packets of the torrent may be intelligently aware of their association to one another, or the association may be controlled by software on a server or other network location utilizing one or more of a digital media index file, packet group listing file, listing of servers containing desired digital media files, or other similar proprietary file transfer control software. In a preferred object of the invention during a server-client, or peer to peer download of a digital media file, an encrypted reassembly index file or other file download control software and the first needed packets that correspond to the beginning of the media file are sent from the closest locations to permit the quickest real time decryption and use of a digital media file under streaming or download conditions.

In one object of the invention, for times when the internet is unavailable, encrypted packets for a particular media file and its encrypted reassembly index file may optionally be stored in separate locations on a receiving end user computer or network and multiple packets may optionally be packed into single or multiple files on the receiving computer or network. Such file and packet location information may be added to an index upon their receipt and stored in an encrypted or non-encrypted fashion. In another object of the invention, other proprietary storage and retrieval mechanisms may be utilized to accomplish the same or similar effects.

A preferred object of the invention is to provide a decryption system that decrypts multiply encrypted media via multiple decryption steps, wherein the a media player that is capable of playing the encrypted media performs a final decryption step during playing of media packets. Further preferred is such a system that includes an encryption system having at least two, preferably three encryption steps. Even more preferred is such a system that reduces the size of the encrypted file to a size that is many times smaller as compared to the original media file and utilizes loss-less encryption, i.e., the decryption reliably restores the original non-encrypted file without any loss of information. Most preferred is an encryption/decryption system wherein the data is encrypted at least three times.

Another object of the invention is to provide a method and software for capturing consumer factor information of an end user and cross-referencing with a data decryption key or keys contained within a file or files known as a “library card” within the context of this application.

Additional objects, advantages and novel features of the invention will be set forth in part in the description which follows, and in part will become apparent to those skilled in the art upon examination of the following, or may be learned by practice of the invention.

### DETAILED DESCRIPTION OF THE INVENTION

### Definitions and Nomenclature

“Library card” or “digital media access rights card” or “digital media access rights key”, as used in the specification and the appended claims refers to a computer file or files that includes unique end user or end user machine information and keys associated with an individual person, an individual computer system, or both that may be used with an information decryption system to present decrypted digital information to just that particular individual, on that individual computer system, or both. For an even higher lever of security the library card, digital media access rights card, or digital media access rights key, can be associated with one or more other unique device and/or unique user identifier, such as an imbedded software or hardware identifier in a device or in the case of a unique user identifier . . . a password system, a retinal scanner identifier, a unique electronic identity card, a fingerprint recognition device or the like.

The term “digital media” refers to digitized audio, video or synchronized audio and video, and even to end user computer production software or games. In some cases, the digital media is actually software that permits network access of a particular end user, particular machine, or both, to a particular communications network.

The term “encryption” in the context of digital media refers to the use of one or more algorithms to translate digital information into a form that is not readable without the use of a hardware key, software key, or both, in combination with a software routine that can convert the encrypted file back into its original form. The use of the phrase “multiply encrypted” refers to a process of subjecting encrypted data to one or more additional encryptions.

The terms “decryption” and “multiply decrypted” are the opposite (reverse) procedure as described in “encryption” and “multiply encrypted” procedures described above and use one or more keys and/or software algorithm libraries to accomplish returning encrypted information to its original un-encrypted form.

The term “metadata” in an object data programming language context refers to information about the content of programming objects or data objects. One may think of it in lay terms as a description summary or index for describing present content or possible future content for an object programming language object. For example, chunks or pieces of digital data (whether encrypted or decrypted) may exist in an object or in a group of objects that are linked together in an object schema (structure or order). For example, metadata may be added to or encapsulate packets of fragmented digital media files to create data objects that can be associated with each other as belonging to a similar class or digital media file by other identifying software, or through self aware software implemented methods.

Other object programming language terms and internet terms are to be given their ordinary and expected meaning within the context of this application. A meaning for such terms can be readily obtained by reviewing descriptive literature that is available from the author and provider of such object programming languages.

The term “distributed intelligent torrent exchange” or “DITX” is based upon the concept of packets of information that are embedded with metadata that causes the packets to become programming objects that are self-aware and are also aware of the group of objects to which they belong, or causes the packets that belong together to be identifiable by other software implemented methods. Therefore a DITX exchange is where an end user, machine device or network requests a media file from a distributed computer system (such as the internet or another distributed network) and an intelligent torrent of packets are sent like a swarm of bees from multiple distributed locations to the requesting location. The DITX file transfer results from a DITX request initiated by an end user location that prompts the self-aware individual packets to respond by intelligently requesting their machine or network location to send a torrent of packets to the requesting location where they are unencrypted and re-assembled into the media file needed by the requestor, or prompts software to identify multiple locations for the related packets and to control their bit torrent transfer to the requesting location. Since the individual packets are self-aware, or can be controlled by bit torrent software that can identify the packet locations, multiple locations can send an intelligent swarm of packets to the requesting location and provide a “parallel” instead of a “serial” file transfer exchange that is much faster than obtaining packets serially from one or more locations. This maximizes the bandwidth file download time, and still provides a method for a file transfer exchange that will require decryption and reassembly of the individual packets by the end user location whereby direct or indirect payment for use of the media file can be managed and controlled by the ultimate owner of the media file without requiring a central repository of the ultimate owner of the media file and the policing of all persons to whom the file has been transferred.

A “digital media access card DITX file” is a media file that does not exist as a single decrypted file on an end user machine, but instead exists as a single file or set of files containing a collective of scrambled, encrypted, or both scrambled and encrypted, individual packets of information (scattered fragment encryption technique) that may be separated into individual packets along with an encrypted reassembly index or other proprietary assembly software and at least one de-encryption software module. When the de-encryption software module determines from the digital media access card (or digital media access key, or library card) identifier that the end user, the end user machine, or both has permission to access the media file the software module utilizes the encrypted reassembly index to decrypt the individual packets in their proper order to provide the media file, or a portion thereof, for use of the end user.

A “NAN-e” device is a device that is embedded with a unique identifier chip or software that can be associated with a unique individual or unique machine to whom that device belongs, such as through a specific digital media access rights card (digital media access rights key, or library card) holder identifier system, wherein the digital media access rights card, digital media access rights key, and library card are defined as above.

An “iTEN” or “intelligent true edge network” is a network where individual locations on the network use a NAN-e identifier, a library card identifier or a combination to permit the network to conclusively identify an end user location on a network, which then allows each location on the network to truly act as a distributed network where each location is not only a user (a “client”) but also a provider (a “server”) on the network. True intelligent two-way or multi-way networking is seamlessly provided as a result of exact identification for each location on the network. Such a network provides much better security and facilitates electronic commerce in a way that was never before possible.

### Overview of the Invention

The present invention is based upon the discovery of unique distribution methods and systems for digital media distribution made possible by proprietary ways to encrypt digital information and unique software implemented methods to associate or link the real-time decryption of that encrypted digital information with a particular end user, with a particular machine for digital media file access, or associated with both a particular end user and a particular machine for permitted access. Such discoveries of proprietary encryption and decryption techniques associated with digital access media rights keys, such as decryption via a scattered fragment encryption technique in combination with an encrypted reassembly index and a de-encryption software or hardware module make possible the management of digital media rights access keys or cards in association with digital media files and permit distribution of digital media files via server-client communications, peer to peer communications, or both types of communications without requiring prior payment of digital media access rights. The digital information of the digital media file is reliably encrypted and proper digital media access permission is required to decrypt and access the digital information obtained from whatever originating source or distribution method. In real time digital media access rights can be granted access to the end user or a particular machine for the digital media file access regardless of how the digital media was obtained by the requester. Moreover, a third party can elect in advance to provide digital media access rights to an end user at that third party's expense in such a way that the third party can pay for digital media access rights for a particular target audience when that audience end users request digital media access rights with third party payment in exchange for specifically targeted advertising to the audience. Thus, the end user can elect to pay for the access or to allow a third party advertiser to pay for the access (when available).

### Non-Limiting Description of Digital Media Access Rights File Examples

The basic premise of such a server-client, peer to peer, or combination server-client and peer to peer distribution framework decoupled from digital media access rights granting is to permit accelerated collaborative content (media, images, audio, etc) sharing and distribution in a way that assures the media producer receives their just remuneration for end user access to the collaborative digital media file content.

One embodiment of the present invention provides software implemented methods, a computer system including software and hardware for such implemented methods, and a business method for accurately allowing end users of digital media files to pay for their access to such files, or a method for connecting end users of digital media files with product advertisers who wish to target them with selected advertisements and to pay for their digital media files access, whereby the method includes use of a computer system with at least one method step for accurately identifying the end user of the digital media or for accurately identifying a machine upon which a digital media file will be permissibly accessed, and at least one method step for an end user to authorize individual payment for digital media that will be acquired from a peer to peer download or from a server client download, or alternatively, for a product advertiser to use a computer system to authorize payment for such digital media access of an end user or end user machine by selecting the target group to which the end user belongs or to authorize payment for access to a digital media file that is likely to be accessed by a high percentage of end users belonging to a group desired to be targeted an advertiser.

In a preferred embodiment of the invention, the distribution method involves the end user step prior to accessing a digital media file that has been downloaded or is about to be downloaded from a server-client communication, from a peer to peer communication, or is otherwise acquired, of the end user interacting with a software implemented interface presenting the end user with the choice of paying for their digital media access or for electing third party payment in exchange for permitting one or more advertisers or ads to be displayed for the end user. In a particularly preferred embodiment of the invention, the business (or distribution) method comprises use of a computer system or other software implemented methods to register or record data of end users for a digital media access rights card whose unique identifier key (or keys) can be utilized in a system to initiate payment authorization or for initiating decoding of encrypted media or for permitting third party payment authorization prior to obtaining the right to decode encrypted media for access.

In another embodiment of the invention, a registration step for obtaining a digital media rights access card or digital media access rights key include requesting adequate information from the registering end user that is related to marketing factors or personal information such that the end user may be identified with a particular class of consumers that share at least one marketing factor in common, while optionally preserving a digital media access rights requester's individual identity, or a particular digital media file may be associated in advance of such a request with a particular class of consumers by an advertiser with has done research or obtained research results with respect to the classes of persons that generally access such a digital media file. The digital media files access rights card or key may be cross-referenced with one or more of the end user's consumer information or a particular end user machine, and may be identifiable to a media player system having decoding information such that the player system will allow the digital media access rights card or key end to grant the end user access to digital media files by initiating decoding of such media files.

In an optional embodiment of the invention, a digital media file access rights card or key can permit an end user to forego viewing an advertisement, or being targeted by an advertiser by agreeing to directly authorize their own payment of a media use fee for the right to access the digital media whereupon decoding can occur that is a result of cross-referenced authorized payment of the media use fee with a digital media rights access key that may be tracked by associated software logic to a particular end user, a particular machine, or both. The business method may comprise a method for encrypting and decoding (decrypting digital media) that is more fully described herein, or may use any other proprietary encrypting and decoding method that is acceptable to a digital media files owner.

An important embodiment of the invention provides software implemented methods and a computer system (particularly preferred is a computer system attached to the internet, or a mobile computer system or other media receiver such as a telephone or PDA) and a method for reliably encrypting a digital media file in a proprietary encrypted format that is reasonably secure against hackers. The digital media file may be equipped with imbedded information regarding where advertisements can be inserted, or when advertisements can be played . . . such as before the media is played or simultaneously with the media in a window, banner or background. Further the digital media file may have imbedded information that can result in end user liability if the end user accesses or changes a digital media file or file component, or liability to a third party who impermissibly accesses a modified digital file or file component beyond the scope of granted digital media access rights.

A preferred embodiment of the invention includes the use of a proprietary encryption technique in combination with a proprietary decryption method for reassembling decoded fragments into a digital file in real time that will only initiate and continue decoding and reassembly of the media file, or a portion thereof, if unique user key(s) are present that give either the end user or the end user machine, or both, access to the digital media at the time of decoding and reassembly of the digital media file, or portion thereof.

In another preferred embodiment of the invention, an encrypted reassembly index or other digital media access rights key may be required to be present or accessible over a network before access to the digital media file or a portion thereof is available to an end user, to an end user machine, or both.

In yet another embodiment of the invention, a method step is utilized to fragment a media file into media data packets (also known as bits, units, or objects of information) and encrypt the separate media file into uniquely identifiable packets whose order for decryption and playing of the packets is included within a separate encrypted reassembly index file, or the order is communicated in another proprietary manner such as by a software implemented method. In a preferred embodiment of the invention, the decryption of digital information methods operate in real time during permissible digital file access and only provides a buffer of decrypted media information that exists in the memory of a computer while the encrypted digital media file or portions of the encrypted file are being accessed and decrypted, such as encrypted media data packets. The digital media file being decoded may exist in a permanent media or may exist only as part of a streaming media file available via a communications network, such as by a satellite, cable, internet, intranet or telephone network. Preferably, encrypted packets are sent to the end-user in a non-linear or random fashion and may be simultaneously sent to an end user from multiple download server locations or from multiple peer to peer locations. One preferred embodiment of the invention provides for server controlled server to client or peer to peer bit torrent downloads of proprietary encrypted digital media files.

Another preferred embodiment of the invention permits software implemented methods to transmit the individual packets and the encrypted reassembly index file from multiple locations simultaneously and asynchronously to an end user via a true distributed intelligent torrent exchange (DITX) transmission. A DITX transmission may be generally described as a file exchange where a torrent of packets for a media file are sent from multiple locations on the internet (or from other network locations) to a media requesting end user who is asking for a particular media file (a torrent of packets is sent like a swarm of bees from different locations that have the packets available for sending) and individual packets of the torrent may be intelligently aware of their association to one another, or the association may be controlled by software on a server or other network location utilizing one or more controlling methods selected from a digital media index file, a packet group listing file, and a listing of servers containing desired digital media files, or by another similar proprietary file transfer control software. In a preferred embodiment of the invention, during a server-client, or peer to peer download of a digital media file, an encrypted reassembly index file or other file download control software and the first needed packets that correspond to the beginning of the media file are sent to a requester from the closest locations to permit the quickest real time decryption and use of a digital media file under streaming or download conditions.

In one embodiment of the invention, for times when the internet is unavailable, the digital media files distribution methods provide that encrypted packets for a particular media file and its encrypted reassembly index file may optionally be stored in separate locations on a receiving end user computer or network and multiple packets may optionally be packed into single or multiple files on the receiving computer or network. Such file and packet location information may be added to an index upon their receipt and stored in an encrypted or non-encrypted fashion. In another embodiment of the invention, other proprietary storage and retrieval mechanisms may be utilized to accomplish the same or similar effects.

A preferred embodiment of the invention provides a decryption system with software implemented methods that decrypt multiply encrypted media via multiple decryption steps, wherein the a media player that is capable of playing the encrypted media performs a final decryption step during playing of media packets. Further preferred is such a system that includes an encryption system having at least two, preferably three encryption steps. Even more preferred is such a system that reduces the size of the encrypted file to a size that is significantly smaller as compared to the original media file and utilizes lossless or near lossless encryption, i.e., the decryption reliably restores the original non-encrypted file without any loss, or without any substantial loss of information. Most preferred is an encryption/decryption system wherein the data is encrypted at least three times.

Another embodiment of the invention provides software implemented methods for capturing consumer factor information of an end user and cross-referencing that data with a digital media rights access file associated with a decryption key or keys contained within a file or files known as a digital media access rights card or key within the context of this application.

In one more preferred embodiment, the invention provides software implemented, hardware implemented, or a combination of software and hardware implemented methods for digital media file distribution across a communications network by a peer to peer file transfer method, server to client transfer method or combination server and peer transfer method in association with methods for digital media file access management, comprising:

(a) providing secure digital transfers of digital media, by utilizing proprietary encryption and decryption methods with access protocols and rights as defined by associated digital media rights keys that only permit digital file access when proper payment for digital media access rights have been directly or indirectly completed or authorized,

(b) providing adequate payment to the owners of digital media rights by a direct method from end users, or by an indirect method of having advertisers pay for use of the digital media file access in return for placing advertisements on the end users machine, or both, wherein the advertisements are associated with access of the digital media files, associated with the end user for a period of time or associated with both, and

(c) providing a means for clearly identifying the end user of digital media, with respect to one or more of the following factors: (i) the beginning and ending period of time in which access to digital media file is granted for an end user, (ii) the identity of the end user to whom access to the digital media access is granted, and (iii) the identity of the machine on which access to the digital media is granted.

As exemplified above, the use of a digital media access rights card, key or similar file in the context of advertisers or sponsors targeting consumers will permit freer and faster distribution of digital media files while ensuring that producers of digital media receive payment of access to digital media files. Also, digital media files producers will have more freedom to decide how payment is made to them for such accesses. This uncoupling of distribution and access will permit savings for digital media files producers with respect to policing distribution, since how a file is acquired is not important and only the digital media access rights need to be policed and managed.

Without further description, it is believed that one of ordinary skill in the art can, using the preceding description, make and utilize the business method and associated computer systems of the present invention and practice the claimed methods. The examples of encryption and decryption specifically point out preferred embodiments of the present invention, and are not to be construed as limiting in any way the remainder of the disclosure. Such examples are non-limiting in that one of ordinary skill (in view of the above) will readily envision other permutations and variations on the invention without departing from the principal concepts. Such permutations and variations are also within the scope of the present invention.

What is claimed is:

1. A software implemented, hardware implemented, or a combination of software and hardware implemented method for digital media file distribution across a communications network by a peer to peer file transfer method, server to client transfer method or a combination server and peer transfer method in association with methods for digital media file access management and digital media access rights fee payments, comprising:
(a) providing secure digital transfers of digital media, by utilizing proprietary encryption and decryption methods with user access methods defined by at least one associated digital media rights key that only permits an end user or particular machine digital file access when proper payment for digital media access rights have been directly or indirectly completed or authorized,
(b) providing adequate payment to the owners of digital media rights by a direct method from end users, or by an indirect method of having advertisers pay for use of the digital media file access in return for placing advertisements on the end users machine, or both, wherein the advertisements are associated with access of the digital media files, associated with the end user for a period of time or associated with both, and
(c) providing a means for clearly identifying the end user of digital media, with respect to one or more of the following factors: (i) the beginning and ending period of time in which access to digital media file is granted for an end user, (ii) the identity of the end user to whom access to the digital media access is granted, and (iii) the identity of the machine on which access to the digital media is granted.

2. A digital media file distribution and digital media rights management method according to claim 1, wherein the implemented method includes (i) providing a computer system with at least one method step for accurately identifying the end user of a digital media file, or for accurately identifying an end user machine upon which a digital media file will be permissibly accessed, and (ii) at least one method step for:
(a) for an end user to authorize individual payment for digital media that will be acquired from a peer to peer download or from a server client download, or combination download method, or
(b) for a product advertiser to use a computer system to either (i) authorize payment for such digital media access of an end user or end user machine by selecting the target group to which the end user belongs, or (ii) authorize payment for access to a digital media file that is likely to be accessed by a high percentage of end users belonging to a group desired to be targeted an advertiser.

3. A digital media file distribution and digital media rights management method according to claim 2, which further comprises requiring an end user for a digital file in a software implemented step prior to accessing a digital media file that has been downloaded, or is about to be downloaded, from a server-client communication, from a peer to peer communication, or otherwise acquired, to first access a software implemented interface presenting the end user with the choice of paying for digital media file access or for electing third party payment in exchange for permitting one or more advertisers or ads to be displayed for the end user.

4. A digital media file distribution and digital media rights management method according to claim 3, comprising software implemented methods to register or record data of end users for generation of a digital media access rights card or key whose unique identifier key (or keys) can be utilized in a system to initiate payment authorization or for initiating decoding of encrypted media or used for permitting third party payment authorization prior to obtaining the right to decode encrypted media for access.

5. A digital media file distribution and digital media rights management method according to claim 3, wherein software implemented methods permit an end user to forego viewing an advertisement, or being targeted by an advertiser by agreeing to directly authorize payment of a fee for the right to access the digital media whereupon decoding can occur that is a result of cross-referenced authorized payment of the media use fee with a digital media rights access key that may be tracked by associated software logic to a particular end user, a particular machine, or both.

6. A digital media file distribution and digital media rights management method according to claim 1, wherein the distributed digital media file includes imbedded information regarding where advertisements can be inserted, or the timing of when advertisements can be displayed or otherwise presented to the end user selected from one or more of: (i) before the digital media file access is granted, (ii) simultaneously with access to the digital media file in a window, banner or background, and (iii) for a period of time after the digital media file is accessed by the end user.

7. A digital media file distribution and digital media rights management method according to claim 1, wherein the distributed digital media file includes imbedded information for tracking its access, modification or distribution that can result in end user liability if the end user accesses, modifies, or deletes a digital media file or file component beyond the scope of the digital media rights agreement, or result in liability to person who impermissibly access a modified digital file or file component without first authorizing direct or indirect payment of digital media rights with respect to access.

7. A digital media file distribution and digital media rights management method according to claim 1, wherein the distributed digital media file exists as a single file or as a set of files containing a collective of scrambled, encrypted, or both scrambled and encrypted, individual packets of information that may be separated into individual packets along with an encrypted reassembly index or other proprietary assembly software and wherein the digital media file is associated with at least one de-encryption and digital rights management software implemented method that will permit authorized digital media file access.

8. A digital media file distribution and digital media rights management method according to claim 7, wherein the method utilizes a proprietary encryption technique in combination with a proprietary decryption method for reassembling decoded fragments into a digital file in real time that will only initiate and continue decoding and reassembly of the media file, or a portion thereof, if one or more unique user keys is present that give either the end user or the end user machine, or both, access to the digital media at the time of decoding and reassembly of the digital media file, or portion thereof.

9. A digital media file distribution and digital media rights management method according to claim 8, wherein the method utilizes a proprietary encryption technique in combination with a proprietary decryption method requiring an encrypted reassembly index or assembly key to be present or accessible over a network before access to the digital media file or a portion thereof is available to an end user or an end user machine, or both.

10. A digital media file distribution and digital media rights management method according to claim 9, wherein the method utilizes a proprietary encryption technique in combination with a proprietary decryption method and the decryption of digital information operates in real time and only provides a buffer of decrypted media information that exists in the memory of a computer while the media is being accessed and while the encrypted file or portions of the encrypted file or encrypted media data packets are being decrypted, and may not exist in a permanent media or exist only as part of a streaming media file available via a communications network, such as a satellite, cable, internet, intranet or telephone network.
